(19) United States
(12) Patent Application Publication
(10) Pub. No.: US 2003/0165793 A1
(43) Pub. Date: Sep. 4, 2003

(54) System for dispensing viscous materials

(76) Inventors: Dan Yobel, Franklin Lakes, NJ (US); Richard Pitz, New York, NY (US)

Correspondence Address: RICHARD J. PITZ DMD, 400 E 54TH ST, NEW YORK, NY, 10022, US

(21) Appl. No.: 10/090,125

(22) Filed: Mar. 1, 2002

Related U.S. Application Data
(60) Provisional application No. 60/343,081, filed on Oct. 27, 2001.

(51) Int. Cl. A61C 5/04

(52) U.S. Cl. 433/90; 433/32

(57) ABSTRACT

The invention provides for a delivery system where a viscous material such as dental composite is heated by an induction field or by resistance to an electric current. The system comprises at the proximal end a capsule-like cartridge that is self heating. The capsule may be fabricated of any number of heat conducting polymers or doped polymers that are susceptible to induction fields or any material that will heat when an induction current is applied. In the second instance the capsules may have a resistance wire of the appropriate metal or any other material to allow heating of the capsule when a current is applied. In the third instance the capsule may have an induction coil embedded in it's wall combined with any type of metal or other material where this becomes the heating device when current of the appropriate nature is applied. In the fourth instance a thin film or foil may be applied to either the outer surface or the inner surface of the capsule such that when a current is applied the foil or film heats and in so doing heats the capsule and the contents.

Coupled with the above described capsule is a delivery device. This hand held device, whether powered manually or electrically forces a shaft to engage a piston embedded within the cartridge to move forward, dispensing the material within the cartridge at it's proximal end. In the manually powered mode, an electrical power source, whether a battery, capacitor discharge or AC/DC current, is used exclusively to activate the various heating methods described above. In the electrically powered mode, a linear stepper motor or other such motor with a proper configuration allows the shaft to engage the piston embedded in the cartridge and allow the material contained within the cartridge to be dispensed at it's proximal end. In the electrically powered configuration the power source described above is used to power the motor as well as the energy to activate the various heating elements described above. In addition where the force needed to extrude the material contained in the capsule, embedded in the device, whether manually or electrically applied to the device, such device may have the induction coil embedded in the barrel extension of the device in such placement as to provide adequate heating of the capsule.

### DESCRIPTION

This application is based on previous application No. 60/343,081 Filing date Oct. 27, 2001

### BACKGROUND OF THE INVENTION

1. Field of the Invention

This invention pertains generally to pressure actuated dispensers, applicators and devices for application of fluid materials, and more particularly to an apparatus which is part of a system which allows conventional dispensing devices to be adapted or modified such that a variety of materials in varying quantities may be dispensed from or applied by a single dispensing device.

2. Description of the Background Art

Various types of dental materials are dispensed from some form of dispensing apparatus (Dragon U.S. Pat. No. 5,061,179). This may facilitate a more ergonomic action or in the case of dental composites, it is ease of placement. This placement may be enhanced visually by the apparatus or it may be used to overcome a drawback of the material itself. Such is the case with many of the light cured resins currently in use

To increase strength, micron sized particles are incorporated into the resin such that when the composite is cured in the tooth, it is esthetically satisfactory and will be able to withstand the chewing forces. Today it is common to have filler content over 80%. Delivery of the material is commonly done with a hand actuated dispenser modified to magnify hand pressure as much as 5 times. Such dispensers are coupled with a cartridge filled with the appropriate material for the task. These cartridges usually are friction fit to the proximal end of the dispenser as a convenience factor. The cartridges are mostly uniform in their circumference, however their length may vary. The opening of the distal end contains a plug that when pushed along the longitudinal axis by part of the dispenser expresses the material from the proximal end of the cartridge. Such orifices may vary in size of opening and the length of the canula that is part of the cartridge may also vary in length.

Owing to the resistance of flow by the very highly filled composites, the orifice of the cartridge can be greater than 3 mm.. Multiple handheld devices that magnified the force necessary to overcome the resistance due to viscosity were patented (Kunkel, et. al U.S. Pat. No. 5,871,354). Patents on the size, shape and orifice opening of the cartridge were issued. In each case it was in overcoming the viscosity problem that drove the research. While the industry tried to market these combinations as convenience item, it noted that there was a problem of placing these materials so as not to have voids, incompletely cured resins and uncovered surfaces.

Dental composite materials are mixtures of liquid resins and suspended particles. Light wavelengths of sufficient energy to cause a reaction are introduced to allow the resin to cure producing a sufficiently strong material to withstand the chewing forces of the mouth. Many types of light sources are used but the nature of the material preclude the immediate setting throughout as with a 2 part chemical set resin system. The initial set starts at the area with the most intense light energy, creating a shrinkage as the material cures to the greatest mass. This occurs regardless of the intensity or wavelength of the light source.

This effect has led to open margins in the first instance which is entirely due to the chemistry of the material. In the second instance, the inability to deliver the material equally to all parts of the preparation, owing to it's size, complex shape (angles, undercuts etc.), and location in the mouth are an operator shortcoming. The second instance may be attributed to the viscous nature of the material. The primary obligation of the procedure is to cover the margins such that a completely cured composite material leaves no gaps, voids or uncured material which may lead to recurrent decay.

To facilitate such coverage, reduce the total shrinkage to an acceptable level, and produce a completely cured resin, the manufacturers recommend a layering technique. Operator technique deficiency, owing to the viscous nature of the material can incorporate voids that will alter the strength and optical properties of the cured material. To overcome the high probability of open margins, the industry introduced a flowable composite with more liquid resins and less filler. This material is placed at the interface of the tooth and retainer (should one be needed) or the floor and sides of the preparation. These flowable composites can be introduced with a canula as small as 25 ga or smaller.

Again, these flowable composites were initially meant to close margins and reduce the overall shrinkage factor. Operator error is introduced in the use of these materials when bubbles are introduced by the manipulation of the canula or when too much of the material is introduced into the preparation. Since more volatile diluents in the resins are incorporated to increase the flow,(Klee, et.al. U.S. Pat. No. 5,876,210, pg. 13,14) (this action reduces the strength and creates greater shrinkage) there is a decided increase in the vapor pressure that occurs when the material goes from room temperature (approx72 F.) to body temperature (98.6 F.), thereby creating tiny bubbles. Any area where there is oxygen present will create an oxygen inhibited layer causing uncured resin that remains uncured.

The overall intent of the manufacturers in their product and it's delivery is to wet the surface of the tooth with the resin, primarily to help seal, and have a homogeneous material against the tooth surface that will, when cured correctly, produce a restoration of sufficient strength to withstand the chewing forces to prevent breakage.

Patents have been issued that deal with the nature of all viscous materials, dealing with orifice openings, size and shape of the material carrier (cartridge, capsule),(Bender, U.S. Pat. No. 5,707,234) means of multiplying forces necessary to overcome this viscosity and size, shape and mechanical properties of the cartridge holder used to dispense such materials. None have been issued where the resistance to flow caused by the viscosity is overcome by applying controlled heat at the point of delivery (generating heat within the capsule itself). Such heat must be applied within a specific range to take advantage of the optimal flow given to the resin component of the mixture. Such heat range must not in any way alter the chemistry or any of the other desirable properties of the material when in a plastic state or when converted to a cured state.

This invention overcomes all the disadvantages of forcing a viscous material through a small opening by altering the plasticity of a mixture by applying controlled heat allowing a component of the mixture to become fluid.

The advantages to such a method and delivery system include: 1) reduction of voids owing to more consistent placement due to increased flow 2) greater wetting of the surface of the tooth with the resins in a more liquid state 3) ease of delivery a) less force required b) smaller delivery tips for better visualization 4) less volatile diluents required, yielding greater strength and less shrinkage 5) use of longer chain resins for greater strength 6) ability to incorporate a filler content to 90% and above without compromising the flow using a standard dental hand delivery syringe 7) the manipulation of the chemistry of the resins such that heating within controlled parameters, will deliver the appropriate delta energy, to initiate a self cure) 8) allow for a two component system to exist in a premixed state in the same cartridge without setting or degrading prior to intended use until the appropriate delta energy is applied.

### BRIEF DESCRIPTION OF THE DRAWINGS

FIG. 1. Is a side elevation of the dispensing device and cartridge that comprises the system in accordance with the present invention.

FIG. 2. Is a fragmentary enlarged top view of the anterior portion of the connection of the dispensing device with the cartridge.

FIG. 3. Is a cross sectional view of the rear of the cartridge showing the electrical connections and the recesses for the mechanical connections of the cartridge with the proximal end of the barrel of the dispensing device.

FIG. 4. Is a angular view, partly broken away of the cartridge showing the embedded metal ribs of one of the preferred cartridges in accordance with the invention.

FIG. 5. Is a angular view, partly broken away showing the embedded resistence coil along with the electrical connection, and mechanical connection, as one embodiment of the cartridge in accordance with the invention.

FIG. 6. Is a side view of the cartridge showing the metal ribs embedded in the cartridge wall surrounded by the barrel extension containing the induction coil, as an embodiment in accordance with the invention.

FIG. 7. Is a longitudinal view of the cartridge containing the coil (induction or resistence), piston nipple, cap, electrical connection and mechanical connection as an embodiment in accordance with the invention.

### SUMMARY OF THE INVENTION

The present invention is system and carrier for the delivery of dental materials primarily composite materials (but not limited to such materials) where the viscosity of the material is changed and other properties of the material is enhanced by the addition of a controlled heat.

The system and carrier is located at the proximal end of a hand held syringe (placement device) that provides either by digital manipulation or a linear step motor or other type electrical motor a force necessary to deposit a determined amount of a dental material (composite) into the tooth preparation. The placement device is electrically powered either by battery or AC current to activate in the first instance an induction coil that will cause the carrier of the material to heat, thereby reducing the viscosity prior to placement. In the second instance the carrier (carpule) itself is the resistance to the current thereby heating the carrier, reducing the viscosity of the material in the carrier prior to placement.

The carriers of the materials (carpule) can be of any size and shape such that it be of an advantageous nature to allow for the proper visualization. Many types of standard carpules are available to fit various handles (syringes, “guns”). Most of these carpules hold approximately 1/2 gram of a light cured composite. Various materials currently on the market will allow a standard polymer material to be manufactured to meet the specifications allowing the temperature of the carpule to be raised over a carefully selected temperature.

Advantages of the heatable carpules (and or carrier of any size) is that multiple types of composite materials is eliminated. One very highly filled material will suffice. The orifice openings of the carpule can be reduced, such that more accurate placement of the material can be accomplished. The properties of the resin are enhanced from both a chemical stand point and their ability to wet the tooth surface. Strength and optical properties are enhanced by allowing a much higher filler content unencumbered by the detrimental viscosity to such materials. Adding controlled heat at the point of placement will allow different chemical composition to be manufactured such that the composite material can be manufactured where a 2 part resin can be incorporated into the same carrier and by adding additional energy (delta 2) a dual cure can be accomplished (chemical and light cure). Since the carpules may be made of a standard size, they can be used without the enhanced embodiment in the standard syringes available on the market.

Of particular importance is the necessity of having a continuous, controlled heat of the material, especially at the orifice. This is to overcome the rapid cooling of the extruded material. Composites by their nature have a low specific heat. Previous methods while using heat sources failed to recognize the nature of the material, such that over time continuous heating will alter the chemistry of the composite resin. This alteration will produce a material that becomes lumpy or produces aggregate particles that will alter the finished product. This is evidenced by altered color, strength and wear characteristics.

The advantage of the method in this application is rapid heating to a precisely controlled heat content of the material with rapid delivery such that the physical and chemical properties are not altered.

### DESCRIPTION OF PREFERRED EMBODIMENTS

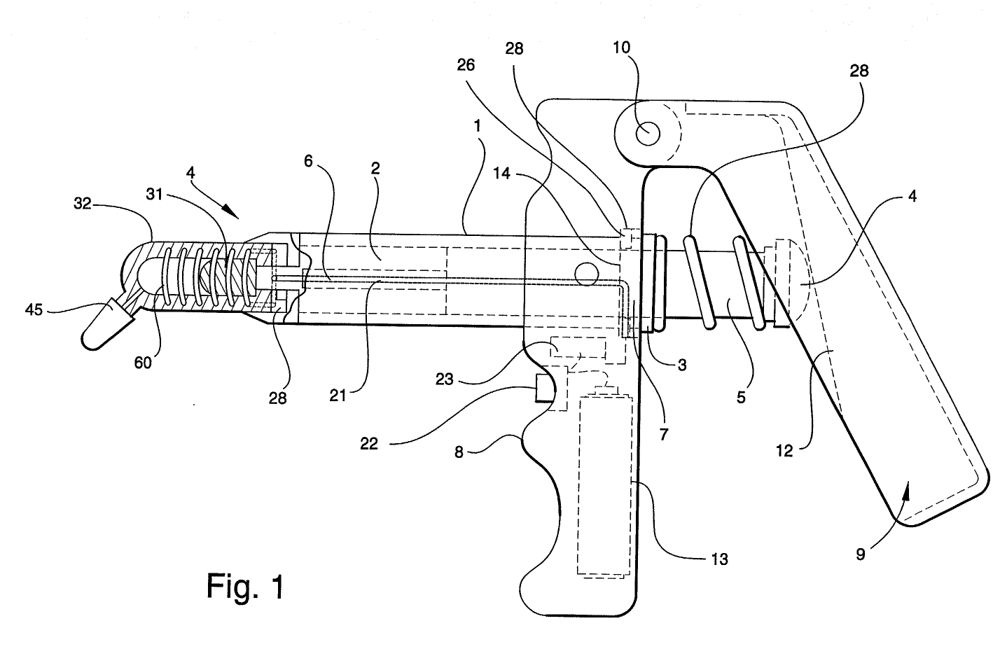

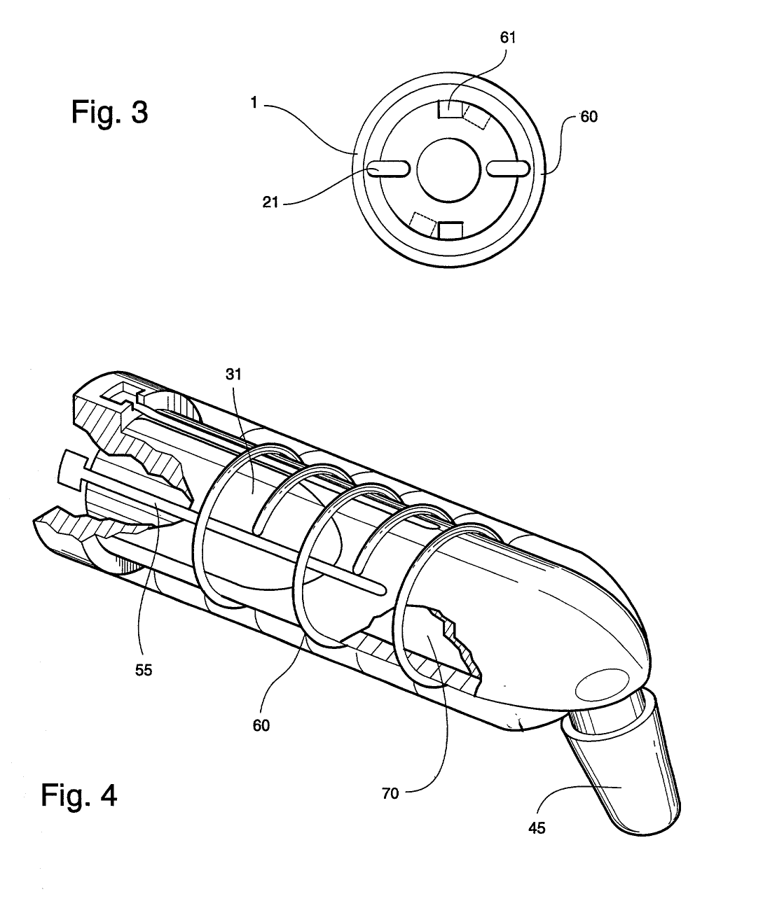

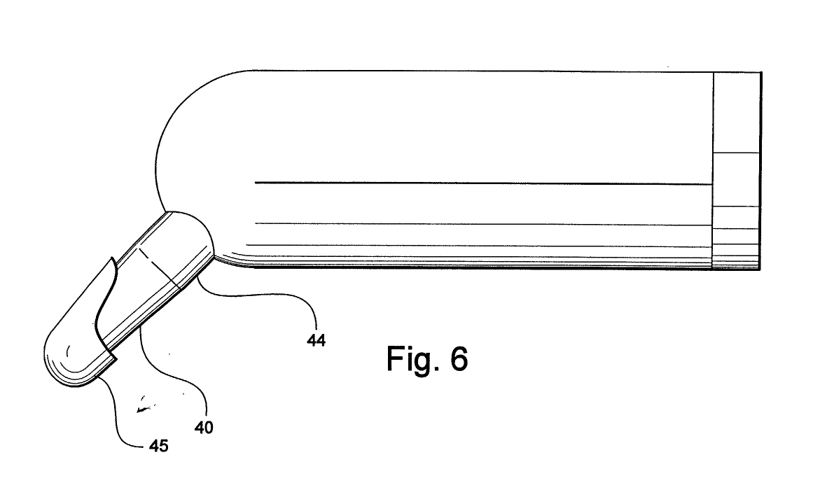

The present invention will now be disclosed in detail with the aid of the embodiments of FIGS. 1 through 7.

FIG. 1 shows and ejector holder of a type especially designed to hold in an operative position a cartridge in conjunction to form a system that embodies the principles of the present invention. The holder comprises a barrel (1) having an interior bore (2) extending from a rearward end (3) toward the forward end (4) thereof for receiving a plunger (5) of the same diameter as that of the interior bore (2) for the major portion of the length of the plunger. The forward end of the plunger having a smaller diameter extension (6).

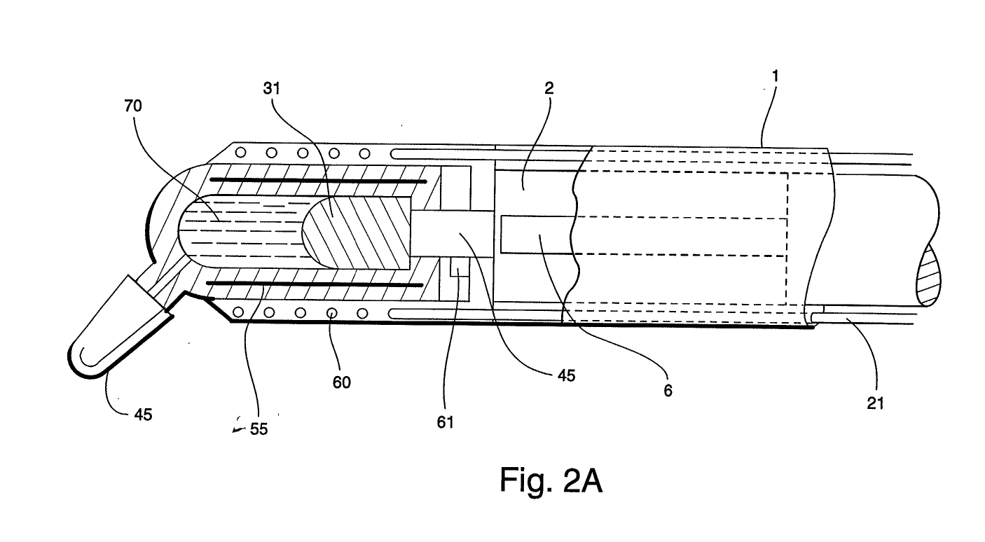

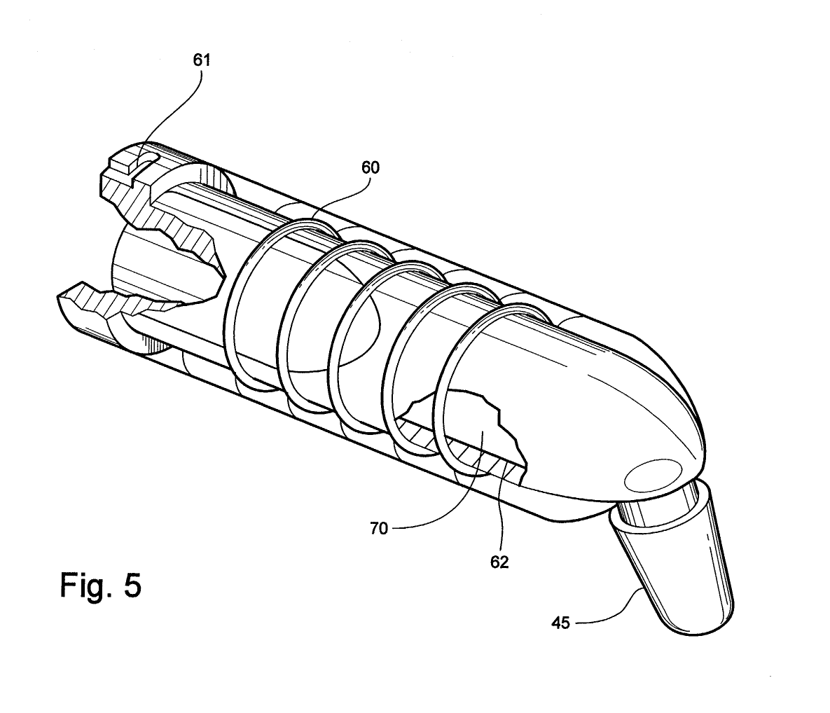

The rearward end (3) of the barrel (1) extends through the handle member (8), the barrel (1) has a flange (7) that is located in a recess of the handle (8) that is perpendicular to the barrel (1). The barrel is then free to rotate within this recess (14) connected to the flange (7) of the barrel (1) is an electrical connection (26) such that when the barrel (1) is rotated the electrical connection is not compromised. The proximal end of the barrel ends in forward bulkhead (15) that allows for the forward end of the plunger (2) to pass through. The bulkhead is of such thickness to allow for an electrical connection to electrical leads (21) running longitudinally from the electrical connection (50) at the proximal end of the barrel, to the distal flange (7) with the associated electrical connection (26). The proximal end of the barrel (1) has forward extensions such as to engage recesses (61) located in the distal face of the cartridge (32) as shown is FIGS. 3 and 5, in such a configuration that these mated extensions and recesses (61) when rotated in the proper direction will give a positive seat between the anterior portion of the bulkhead (15) and the flat portion of the distal end of the cartridge (28).

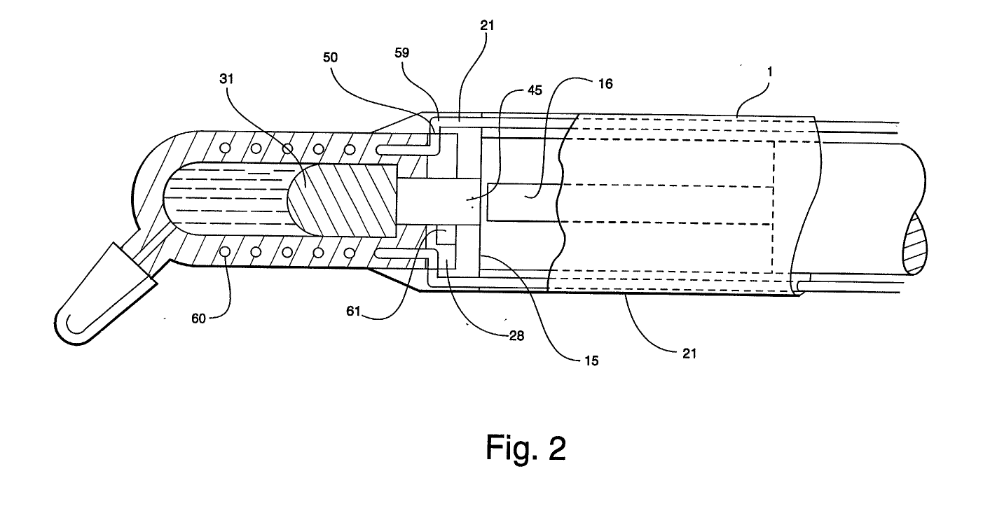

The cartridge (32) has an electrical connection (50) which mates with a concomitant connection in the bulkhead (15) of barrel (1) as shown in FIG. 2. The cartridge (32) has an embedded coil (60) as shown in FIGS. 1 and 2. The cartridge (32) mates with the barrel (1) at it's proximal end which contains a bulkhead (15) allowing for a strong connection of the combined member to become a part of a rotating, electrically conductive component attached to a handle (8).

The handle (8) is pivotally connected to an operating lever (12) through a pivot pin (10) located at the upper end of the handle (9) and the operating lever (12) that is offset laterally to facilitate the operation of the lever (12) with respect to the outer end of the plunger (5) which terminates in a button (11) engaged by the inner surface (12) of the operating lever.

A coiled spring (28) surrounds the distal portion of the plunger between the forward handle (8) and the button (11) for purposes of extracting the plunger (5) when the operating lever (9) is released, following ejection of material from the cartridge (32).

The handle (8) contains an appropriate electrical source (13) such as a battery or capacitor discharge device and/or connection to an electrical outlet through a connecting cable. The handle (8) contains and on/off switch (22) connected to the electrical source (13) in conjunction with a temperature controller device (23) through a feedback thermocouple contained within or on the storage supply, but, even more importantly, the cartridge can be filled at a factory with predetermined quantities of material, by automatic machinery, and sealed therein by application of the piston (31) which, under the circumstance, serves as a closure for the cartridge. The above described design particularly facilitates such operations. Further, during filling, air in the cartridge in advance of the material can be discharged through the nipple (44) until filled and then the open end of the nipple may be suitably and inexpensively closed by suitable seal means, such as a small piece of sheet material having pressure sensitive cement on one side and placing said piece across the nipple in any suitable manner.

In accordance with the invention, a further improved feature for the cartridge comprises providing a preferable cup-shaped cap (45) which is of a suitable shape either to frictionally engage the tip portion of the nipple (44) or either the cap or nipple, or both to secure the cap releasably upon the tip of the nipple in sealed manner. Capt (45) has an outer flange positioned adjacent to the opening of the cap. In closed position, the inner surface of the cap (45) is retained by the nipple with a force sufficient to slightly bend the wall of the cap. This creates enough friction to allow for a secure closure and also allows for easy removal prior to it's intended use.

Moreover, the cap (45) serves and important additional possible feature in that, in addition to sealing the contents of the cartridge in conjunction with the piston (31), the cap may be color coded to any number of purposes, weight or quantity of the material therein, setting time, and otherwise.

Also the body of the cartridge as well as the cap (45) and piston (31) may all be molded from a similar plastic material which is colored suitably to render the items opaque or otherwise impervious to the transmission of ambient light which, if the contents are subject to being set by such light, prevents premature setting thereof.

The foregoing description illustrates preferred embodiments of the invention. However, concepts employed may, based upon such description, be employed in other embodiments without departing from the scope of the invention. Accordingly, the following claims are intended to protect the invention broadly, as well as in the specific forms shown herein. surface of the cartridge (60) (55).

The cartridge (32) which in conjunction with the dispensing device comprises the system is located at the proximal end of the barrel (1). The cartridge (32) is preferably formed by molding from a rigid synthetic resin or plastic material by means of a suitable mold. The intermediate body portion of the capsule (63) is of uniform interior and exterior diameter and extends from a flat open end with female recesses (61) as shown in FIG. 5 for connection to the barrel (1) projections and also has electrical connections (50) that mate with similar connections (59) in the connecting face of the barrel 91). The cartridge is of sufficient thickness (62) to allow for an appropriate placement and configuration of a wire (60) that may be a coil but not limited to such configuration that when an electrical current is passed through creates a rise in temperature through resistance in one method and induction in the second method. The capsule (32) has a thermocouple device (55) to allow for a feedback mechanism to control the temperature of the material in the cartridge (70). Horizontal metal ribs (55) located in a longitudinal direction within the cartridge walls beneath the induction coil (60) become hot when subjected to the proper current and also act as a thermocouple (55) in a form of the invention. In another form of the invention, the barrel (1) is extended to cover the cartridge (32) contains only the horizontal metal ribs (55) and no induction coil (60). The induction coil (60) is located in the barrel (1) as shown in FIG. 2A at the extended end and the electrical connection is with a direct wire (21) to the distal portion of the barrel (1) and connected to an on/off switch connected to the temperature feedback mechanism.

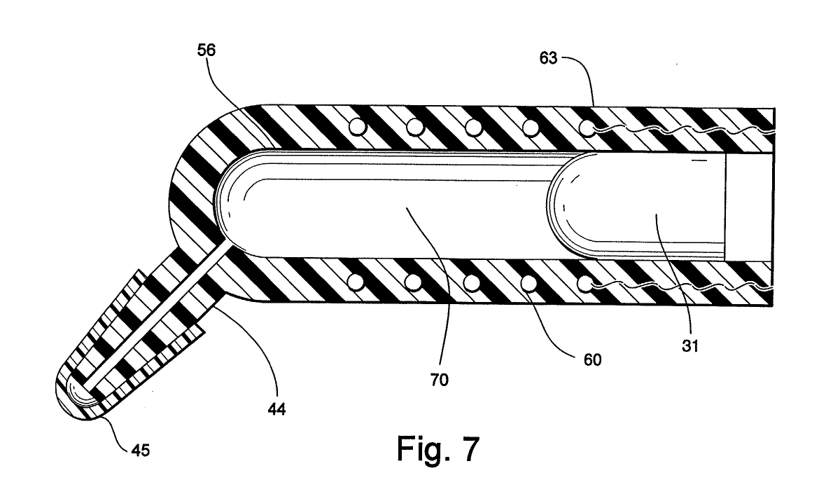

The body of the cartridge (63) extends forward in a uniform manner to a hemispherical closed end with an opening into an angularly placed discharge nipple (40), the opening of which is preferably a very fine dimension of small diameter. To effect the ejection of material from the cartridge (32), such as dental filling material, cement, or other viscous material and the like, for example, the cartridge (32) includes a piston (31) as shown in FIG. 2, which is very closely complementary in diameter to the interior of the cartridge (56) as shown in FIG. 7 and the inner end thereof also is hemispherical and complementary to the interior of the closed end of the cartridge. Without restriction thereto, the outer end of the piston may be flat for engagement, for example in FIGS. 2 and 2A where the proximal end of plunger (5) is moved forward by actuation of the operating lever (9).

Removal of the cartridge (32) from the proximal end of the barrel is accomplished by turning in the appropriate direction allowing the connecting tangs on the proximal end of the barrel(15) to disengage from the female connection (61) in the distal end of the cartridge (28).

From the foregoing, it will be seen that the proximal end of the barrel (15) is especially adapted to receive the particular type cartridge (32) to be used therewith, which is a subject of the system in this application. This does not limit the connecting mechanism to the one previously described but only to demonstrate the necessity of having a positive connection to allow for a secure tight seal and positive electrical conductivity. The connection is very simple, highly effective design to permit a sure and effective adaptation and release.

The cartridge (32) comprising part of the method and the system of the invention not only is capable of serving as receptacle for material to be discharged when filled for example, from

### References Cited

### U.S. Patent Documents

U.S. Pat. No. 4,330,280 April, 1982 Dougherty et al.

U.S. Pat. No. 4,492,840 January, 1985 Lex

U.S. Pat. No. 5,061,179 October, 1991 Dragon

U.S. Pat. No. 5,692,642 December, 1997 Brattesani

U.S. Pat. No. 5,743,431 April, 1998 Brattesani

U.S. Pat. No. 5,707,234 January, 1998 Bender

U.S. Pat. No. 5,871,354 February, 1999 Kunkel

U.S. Pat. No. 5,876,210 March, 1999 Klee

U.S. Pat. No. 6,047,864 April, 2000 Winkler

U.S. Pat. No. 6,116,902 September, 2000 Schodel et al.

U.S. Pat. No. 6,255,625 June, 2001 Baschenis

U.S. Pat. No. 6,312,254 November, 2001 Friedman

What is claimed is:

1. A method and delivery system comprising a cartridge and an actuating device to deliver dental materials.

2. A method and delivery system according to claim 1 where the cartridge contains a viscous dental restorative material.

3. A method and delivery system according to claim 2 where a controlled heat within a specific range is delivered to the cartridge.

4. A method and delivery system according to claim 3 where the delivery of such controlled heat will take advantage of properties of the restorative material in the cartridge according to claim 2 and allow for a significant reduction in the viscosity of the dental mixture.

5. A method and delivery system according to claim 4 whereby a controlled heat at the point of delivery will significantly reduce the viscosity according to claim 4.

6. A method and delivery system according to claim 3 whereby a controlled heat from any source whether exogenous or endogenous applied to the cartridge according to claim 2 will significantly reduce the viscosity of the dental mixture in such cartridge.

7. A method and delivery system according to claim 3 whereby the application of heat in claim 6 will not alter the physical or chemical properties in the mixture prior to dispensing.

8. A method and delivery system according to claim 4 and claim 5 that will not alter the chemical, physical or optical properties subsequent to curing with the appropriate curing method for each specific mixture according to claim 2.

9. A method and delivery system according to claim 3 which will allow dental mixtures containing an A and B component to have their ratios changed such that they may be contained in a single cartridge pre-mixed without undergoing a chemical or physical change.

10. A method and delivery system according to claim 3 which will add the desired delta energy to mixtures in claim 9 to take advantage of the reduction of viscosity in claim 4, thus initiating the self curing reaction.

11. A method and delivery system according to claim 9 where such mixtures will be able to have a dual curing method, one chemically and the other using appropriate exogenous energy sources, usually a light source.

12. A method and delivery system according to claim 1 and 4 where the effect of the significant reduction in viscosity will allow for any size and shape configuration of the cartridge or open end of the cartridge enhances the flow, placement or proper fill by the dental mixture.

13. A cartridge, comprising:
a hollow elongated uniformly cylindrical body of determined length and uniform diameter interiorly and exteriorly and molded from a rigid plastic material, one end of said body being open and formed at the distal extremity to allow for a female recess(es). This/these recess/recesses engage(s) a male projection(s) such that when the cartridge is turned there is a positive, watertight engagement between the cartridge and the barrel of the actuating device.
a discharge nipple of the same material as the body and molded integrally therewith and having a passage there through extending from said closed end of said body to facilitate directing discharge from the cartridge to the interior of an oral cavity, said nipple having a wall, said wall having an outer surface with a proximal diameter proximal to said body and a medial diameter to said body, said medial diameter being substantially equal to said proximal diameter.
a piston having sidewalls closely complementary to the inner walls of said body and inserted into the open thereof to form a combination closure and ejecting means for material when contained in said cartridge, the inner end of said piston being hemispherical and complementary in shape to the interior surface of the closed end of said body to effect ejection of substantially the entire contents of said cartridge when said piston fully inserted into said body of the cartridge and
sealing means comprising a cup-shaped cap removable connected to the discharge nipple on said body to close said outer end of the nipple to seal the contents of the cartridge against ingress of ambient atmosphere and other contaminating matter.

14. The cartridge according to claim 13 further characterized by said body and piston being formed from plastic material suitability colored to render the same impervious to the transmission of ambient light, thereby rendering the cartridge adapted to contain light-curable material and the like in a manner to prevent premature curing of such material while stored in such cartridge

15. The cartridge of claim 13 wherein said cap is color-coded to indicate desired properties of the contents of the cartridge

16. A cartridge of claim 13 wherein said wall formed by the differing diameters of the inner surface and outer surface contains a wire of appropriate configuration with leads passing through the distal end of said cartridge forming a secure direct circuit withconnecting leads in the barrel of the connecting actuating device.

17. A cartridge of claim 16 where the wire contained between the inner wall and the outer wall of the cartridge is fabricated of a material such that when a current is passed through such wire that a heat is generated by such electrical resistance of the embedded wire.

18. A cartridge of claim 13 and 16 has a thermocouple of appropriate means that is placed either within the cartridge wall embedded in the plastic or is located on the inner surface or outer surface of the cartridge.

19. A cartridge of claim 17 and 18 where a thermocouple of appropriate means will interact with the electrical current of claim 16 by such methods of control appropriate to the method and the system to allow for control of the temperature of such embedded wire as in claim 17.

20. A cartridge cf claims 16 and 18 where the coil embedded in the wall of the cartridge is of such nature, that when an electrical current of the appropriate nature is passed through such coil from the connection to the actuating device, an induction field is created within the coil.

21. A cartridge of claim 20 where horizontal rods of an appropriate material running longitudinally with the length of the barrel but not in direct connection to the coil in claim20 are located within the walls of the cartridge such that they become heated when the appropriate current is applied to the induction coil.

22. A cartridge of claim 20 where the longitudinally directed rods located in the wall of the cartridge can act as a thermocouple as in claim 19.

23. A cartridge where the rigid container is fabricated from any material, such as metal, doped thermally conductive polymers and the like, such that when a current is applied, directly or indirectly heat will be generated on the surface or within the walls of the cartridge.

24. A cartridge where the application of any spray, ink, decal and the like that when a current is applied heat will be generated withing the walls or on the surface of the cartridge.

25. A cartridge where any material as directed in claims 16 through and including 24, where a current of any means is directed to create heat within or around the cartridge of claim 13.

26. A cartridge as in claim 25 where a current of any means directed to a cartridge in claim 13 is used to increase the temperature of the material within such cartridge, in such manner as to decrease the viscosity, so as to effect the use of such material as in claim 12.

27. A cartridge as in all previous claims, containing materials such that when an appropriate current is applied will undergo a viscosity change to effect their delivery, can be used in commerce and industry other than dentistry.

28. A cartridge as in claim 13, containing elements of any configuration, of any appropriate material such that when an appropriate energy field generated from an induction coil not contained within the cartridge itself, will cause such configured elements to heat.

29. A cartridge as in claim 23 where and induction field not contained within the cartridge itself will cause the cartridge to heat.

30. A cartridge fabricated from any material with a high specific heat to take advantage of rapid heating and slow cooling.

31. A cartridge in claim 30 combined with any polymers currently used in the fabrication of dental cartridges, but not limited to such fields where a rapid heating and slow cooling of such cartridge is achieved. Such polymers as polypropylene, polyvinylchloride, polyetheylene but not limited to such materials.

32. A cartridge as in claims 30,31 where heat is applied from any source.

33. A cartridge combined with a delivery device.

34. A cartridge as in claim 13 combining any and all combinations of the embodiments of claims 13-32 inclusive combined with a delivery device.

35. A delivery device coupled with a cartridge containing any or all of the embodiments as stated in claims 13-31 inclusive.

36. A delivery device for dispensing a paste material from a cartridge, said delivery device comprising:
a housing comprising a forward and rearward end; said housing accommodating a cartridge containing a paste material at said forward end;
a removable plunger slidably arranged in said rearward end of said housing and acting on the cartridge for dispensing the paste material when actuated;
a pivot handle pivotably connected to said housing for actuating said plunger;
at least one securing tongue connected to said housing;
at least one securing tongue releasably securing the cartridge at said housing end.

37. A delivery device as in claim 33, containing a barrel connected to a handle.

38. A delivery device as in claim 34, containing a barrel of a thermally non-conductive, high heat resistant polymer that is freely able to rotate at it's connection with the handle.

39. A delivery device as in claim 35, containing a barrel that has a flange at it's distal end.

40. A delivery device as in claim 36, where the barrel fits into a recess in said handle in an appropriate configuration and fit, such that the barrel may be rotated.

41. A delivery device as in claim 37, having a hollow cavity from it's distal end to it's proximal end to accommodate a plunger.

42. A delivery device as in claim 38, where said plunger has an extension of a smaller diameter extending from its proximal end.

43. A delivery device as in claim 39, where the plunger extension is of such a diameter as to engage the piston located in the cartridge as in claim 13.

44. A delivery device as in claim 40, where the plunger extension travels in a longitudinally direction for a certain distance to expel completely the substance contained in said cartridge as in claim 13.

45. A delivery device as in claim34, where the barrel contains a(n) appropriate electrical connection(s) on it's proximal face.

46. A delivery device as in claim 42, where the electrical connection of the barrel, connects with an appropriately located electrical connection located in the distal face of the cartridge as in claim 13.

47. A delivery device where the barrel as in claim 34, has an extension of such length as to cover the cartridge from it's connection surface within the barrel to such length that the dispensing tip of the cartridge as in claim 13, is not impeded from performing in an adequate manner.

48. A delivery device as in claim 44, where the extension of the barrel contains an induction coil.

49. A delivery device as in claim 45, where the induction coil is placed within the barrel to provide the optimal induction field such that the material contained within the cartridge is heated to it's optimum temperature in the shortest time frame without degrading the material contained within the cartridge.

50. A delivery device as in claims 42-46, inclusively where connecting leads for the appropriate current are contained within the wall of the barrel and run distally to the handle of the dispensing device as in claim 33.

51. A delivery device as in claim 47, where connecting leads are affixed to a current on/off switch located within the handle.

52. A delivery device as in claim 48, where a temperature control device, is connected to the appropriate power source.

53. A delivery device as in claim 49, where the temperature control device is connected to a thermocouple of the appropriate nature in a feedback mechanism through the connecting leads, either to the cartridge or the material contained within the cartridge.

54. A delivery device as in claim 50, where the connection of the rotating barrel, containing the electrical leads contains and appropriate electrical contact such that when the barrel is rotated, the electrical current is not compromised.

55. A delivery device as in claim 51, where an energy producing device, such as a battery, AC/DC connection or capacitor discharge device is located.

56. A delivery device as in claim 52, where the handle, containing the barrel, has a pivot connection at a position such that a force exerted to a distal handle will cause the plunger to move forward in a longitudinal direction.

57. A delivery device as in claim 52 where the plunger's distal end has a round surface with engages an incline such that when force is applied to the distal handle, a smooth horizontal movement of the plunger is made as the incline in the distal handle and the rounded end of the plunger engage.

58. A delivery device as in claim 54, where the distal length of the plunger between the distal handle and the distal face of the forward handle contains a coiled spring around said length between the distal handle and the distal face of the proximal handle.

59. A delivery device where a linear stepper motor replaces the removable plunger as in claim 33 and is connected to the housing with a bayonet connection, and provides the appropriate electrical connection, such that actuating the on off switch will cause the material within the cartridge as in previous claims to be heated and delivered in prescribed increments with the necessity of manual pressure on the distal handle.

60. A delivery system as in claim 56 any and all combinations of the preferred embodiments of the cartridge and the delivery device, coupled with the linear stepper motor will not be compromised.

61. The present invention, is in no way restricted to the specific disclosure of the specification and drawings, but also encompasses any modifications within the scope of the appended claims.
